(19) United States
(12) Patent Application Publication
(10) Pub. No.: US 2024/0279403 A1
(43) Pub. Date: Aug. 22, 2024

(54) Polymer material with phase-separated structure obtained by controlling the number of branches

(71) Applicants: The University of Tokyo, Tokyo (JP); GELLYCLE CO., LTD., Tokyo (JP)

(72) Inventors: Takamasa SAKAI, Tokyo (JP); Mitsuru NAITO, Tokyo (JP); Takuya KATASHIMA, Tokyo (JP); Kosuke MASUI, Tokyo (JP); Hiroyuki KAMATA, Tokyo (JP)

(73) Assignees: The University of Tokyo, Tokyo (JP); GELLYCLE CO., LTD., Tokyo (JP)

(21) Appl. No.: 18/565,147

(22) PCT Filed: Apr. 28, 2023
(86) PCT No.: PCT/JP2023/016921

§ 371 Date: Nov. 29, 2023

(30) Foreign Application Priority Data
May 3, 2022 (JP) 2022-076349

(51) Int. Cl. C08G 81/00; C08G 65/337

(52) U.S. Cl. CPC C08G 81/00; C08G 65/337

(57) ABSTRACT

An object is to provide a novel artificial slime-like polymer material having stability against an external solvent without changing the chemical composition of a main chain skeleton, a solvent, and the like constituting the polymer material and without impairing the viscosity and elasticity of the slime-like material.

It has been found that by controlling the number of branches, terminal connectivity, and concentration of polymer units constituting the polymer material, it is possible to provide a slime-like polymer material that induces liquid-liquid phase separation and thereby control solubility in external solvents.

### TECHNICAL FIELD

The present invention relates to an associative polymer material in which a liquid-liquid phase-separated structure is induced by controlling the number of branches in a polymer unit, bonding property, and the like.

### BACKGROUND ART

A general slime is a substance in which polymers form an association point by supramolecular interaction (ionic bond, hydrophobic functional group, dynamic covalent bond) and form a transient three-dimensional network structure in a solvent such as water. Since the association point has a finite life, the slime is a liquid material having both viscosity and elasticity, unlike a polymer material having a similar composition.

Therefore, a slime-like polymer has been used as a rheology control agent for foods and cosmetics, and studied as an injectable in-vivo tamponade or a drug carrier (for example, Non-Patent Literatures 1 and 2). However, the conventional slime-like polymer is compatible with a solvent, and is dissolved and decomposed by being mixed with the solvent in a liquid in the body or the like, and has a problem in its stable storage property.

### CITATION LIST

### Non Patent Literature

Non Patent Literature 1: Rainer G et al. Br J Ophthalmol, 85:139-142, 2001
Non Patent Literature 2: Ooki T et al. Developmental Cell, 49, 590-604, 2019

### SUMMARY OF INVENTION

### Technical Problem

Therefore, an object of the present invention is to provide a novel artificial slime-like polymer material having stability against an external solvent without changing the chemical composition of a main chain skeleton, a solvent, and the like constituting the polymer material and without impairing the viscosity and elasticity of the slime-like material.

### Solution to Problem

As a result of intensive studies to solve the above problems, the present inventors have found that by controlling the number of branches, terminal connectivity, and concentration of polymer units constituting the polymer material, it is possible to provide a slime-like polymer material that induces liquid-liquid phase separation and thereby control solubility in external solvents, leading to the completion of this invention.

That is, in one aspect, the present invention provides:
<1> a non-gelled polymer material containing a solvent, the non-gelled polymer material having a three-dimensional structure in which a plurality of polymer units are linked such that a first region where the polymer units are densely present and a second region where the polymer units are sparsely present are present in a phase-separated state, wherein the polymer unit includes a polymer unit A group including one or more branched polymers having a total of two or more boronic acid-containing groups in a side chain or a terminal, and a polymer unit B group including one or more branched polymers having a total of two or more diol groups in a side chain or a terminal, the number-average number of functional groups of boronic acid-containing group per molecule in the polymer unit A group is in a range of 3 to 60, and the number-average number of functional groups of diol group per molecule in the polymer unit B group is in a range of 3 to 1500, a total polymer concentration (c) in the polymer material is 0.1 to 100 g/L and ranges from 10⁻³ to 5 times an overlapping concentration (c*) of the polymer units, and when the average number of the boronic acid-containing group or the diol group bonded to another polymer unit per molecule of the polymer unit is N, N satisfies the following relational expression;

$$N > 0.02 + 4 {( c / {c}^{*} )}^{1.5} \qquad [ Mathematical formula 1 ]$$

<2> the polymer material according to <1>, wherein the solvent is water, and the branched polymer constituting the polymer unit A group and B group is a hydrophilic polymer;
<3> the polymer material according to <1>, wherein the branched polymer constituting the polymer unit A group and B group has a polyethylene glycol skeleton or a polyvinyl skeleton;
<4> the polymer material according to <1>, wherein at least one of the polymer unit A group and B group is composed of only bi-, tri-, tetra-, or octa-branched polyethylene glycols;
<5> the polymer material according to <1>, wherein the branched polymers constituting the polymer unit A group and B group all have a molecular weight (Mw) of 5×10³ to 1×10⁵;
<6> the polymer material according to <1>, wherein the boronic acid-containing group is an arylboronic acid optionally substituted with a halogen atom;
<7> the polymer material according to <1>, wherein the diol group has a ring-opened structure of a saccharide derivative;
<8> the polymer material according to <1>, wherein the polymer unit A group includes a combination of polymers having a total of four boronic acid-containing groups at a terminal and polymers having a total of eight boronic acid-containing groups at a terminal, and the polymer unit B group includes a combination of polymers having a total of four diol groups at a terminal and polymers having a total of eight diol groups at a terminal;
<9> the polymer material according to <1>, further including a connectivity adjusting agent; and
<10> the polymer material according to <1>, wherein a connectivity adjusting agent is selected from the group consisting of a saccharide, a saccharide derivative, and a pH adjusting agent.

In another aspect, the present invention provides:
<11> a kit for forming the polymer material according to any one of <1> to <10>, the kit including a container separately storing a first solution containing a polymer unit A group including one or more branched polymers having a total of two or more boronic acid-containing groups in a side chain or a terminal, and a second solution containing a polymer unit B group including one or more branched polymers having a total of two or more diol groups in a side chain or a terminal, wherein the number-average number of functional groups of boronic acid-containing group per molecule in the polymer unit A group is in a range of 3 to 60, and the number-average number of functional groups of diol group per molecule in the polymer unit B group is in a range of 3 to 1500, and the total polymer concentration (c) in the first and second solutions is 0.1 to 100 g/L and ranges from 10⁻³ to 5 times the overlapping concentration (c*) of the polymer units;
<12> the kit according to <11>, wherein at least one of the first and second solutions can further contain a connectivity adjusting agent;
<13> the kit according to <11>, wherein the connectivity adjusting agent is selected from the group consisting of a saccharide, a saccharide derivative, and a pH adjusting agent; and
<14> a method for producing the polymer material according to any one of <1> to <10>, the method including a step of mixing a polymer unit A group including one or more branched polymers having a total of two or more boronic acid-containing groups in a side chain or a terminal, a polymer unit B group including one or more polymers having a total of two or more diol groups in a side chain or a terminal, and a solvent to prepare a polymer solution, wherein the number-average number of functional groups per molecule in the polymer unit A group is in a range of 3 to 60, and the number-average number of functional groups per molecule in the polymer unit B group is in a range of 3 to 1500, the polymer concentration (c) in the polymer solution is 0.1 to 100 g/L and ranges from 10⁻³ to 5 times the overlapping concentration (c*) of the polymer units, and when the average number of the boronic acid-containing group or the diol group bonded to another polymer unit per molecule of the polymer unit is N, N satisfies the following relational expression.

$$N > 0.02 + 4 {( c / {c}^{*} )}^{1.5} \qquad [ Mathematical formula 2 ]$$

### Advantageous Effects of Invention

Conventional slime-like polymers are compatible with water as a solvent, and are dissolved and decomposed when mixed with a body fluid in a living body, so that required properties cannot be exhibited for a long period of time. On the other hand, the polymer material of the present invention can dramatically improve stability while maintaining the characteristics of the slime-like polymer. Therefore, the polymer material of the present invention leads to the design of a novel biomaterial.

### BRIEF DESCRIPTION OF DRAWINGS

FIG. 1 is a phase diagram of a slime. The vertical axis represents an average number N of polymer units bonded to other polymer units per molecule of the polymer units, and the horizontal axis represents a value obtained by normalizing polymer concentrations by overlapping concentrations. Example 1: The result of mixing 8-branched PEG-FPBA and 8-branched PEG-GDL and controlling the bonding property by the addition amount of sorbitol (◯: Phase-separated structure formation, ×: Single phase without phase separation). Example 2: The result of controlling the bonding property by mixing 8-branched PEG-FPBA, 8-branched PEG-GDL, 4-branched PEG-FPBA, and 4-branched PEG-GDL (•: Phase-separated structure formation, +: Single phase without phase separation). Example 3: The result of controlling the bonding properties by mixing the multi-branched PEG-FPBA and the multi-branched PEG-GDL (symbol + in ◯: phase-separated structure formation).

FIG. 2 is an observation image of a sample subjected to fluorescence modification with a confocal microscope.

### DESCRIPTION OF EMBODIMENTS

Hereinafter, embodiments of the present invention will be described. The scope of the present invention is not limited by these descriptions, and other than the following examples, can be appropriately changed and implemented without impairing the gist of the present invention.

### 1. Polymer Material of the Present Invention

A polymer material of the present invention is a slime-like associative polymer which is not gelled (that is, a non-gelled state), and is an associative polymer material having a three-dimensional structure in which a plurality of polymer units are linked such that two phases having different polymer concentrations, that is, a concentrated phase (first region) in which the polymer units are densely present and a dilute phase (second region) in which the polymer units are sparsely present, are present in a phase-separated state. The present invention is characterized in that a slime-like polymer material in which liquid-liquid phase separation is induced is obtained by controlling the number of branches, the terminal connectivity, the concentration, and the like of the polymer unit.

Since the polymer material has such a unique phase-separated structure, the polymer material of the present invention further satisfies the following requirements.
1) a polymer unit constituting a polymer material includes a polymer unit A group including one or more branched polymers having a total of two or more boronic acid-containing groups in a side chain or a terminal, and a polymer unit B group including one or more branched polymers having a total of two or more diol groups in a side chain or a terminal;
2) the number-average number of functional groups of boronic acid-containing group per molecule in the polymer unit A group is in a range of 3 to 60, and the number-average number of functional groups of diol group per molecule in the polymer unit B group is in a range of 3 to 1500;
3) the total polymer concentration (c) in the polymer material is 0.1 to 100 g/L and ranges from 10⁻³ to 5 times the overlapping concentration (c*) of the polymer units; and
4) when the average number of the boronic acid-containing group or the diol group bonded to another polymer unit per molecule of the polymer unit is N, N satisfies the following relational expression.

$$N > 0.02 + 4 {( c / {c}^{*} )}^{1.5} \qquad [ Mathematical formula 3 ]$$

The polymer material of the present invention is characterized in that a three-dimensional network structure and porous structure are formed by this phase separation, and the mesh size is on the order of μm. Here, the first region is referred to as a “concentrated phase” in the relative meaning that the concentration (density) of the polymer units present in the first region is larger than the density in the second region. Preferably, the first region has a concentration (density) of about three times or more that of the second region.

Hereinafter, the polymer unit constituting the polymer material of the present invention and the properties of the polymer material will be described in more detail.

### (1-1) Polymer Unit

The polymer units constituting the polymer material of the present invention can form a non-gel polymer material by being linked to each other, and more specifically, in the final polymer material, the polymer units can form an association having a network structure, particularly a three-dimensional network structure by being linked via a chemical bond by an equilibrium reaction. Such polymer units are preferably hydrophilic polymers.

The polymer unit used in the present invention is a combination of a polymer unit A group including one or more branched polymers having a total of two or more boronic acid-containing groups in a side chain or a terminal and a polymer unit B group including one or more branched polymers having a total of two or more diol groups in a side chain or a terminal. Here, the total of the boronic acid-containing group and the diol group is preferably 5 or more. It is more preferable that these functional groups are present at the terminal. For example, when the polymer unit A group has a bi-, tri-, tetra-, or octa-branched structure, it preferably has a boronic acid-containing group at each branched terminal, and when the polymer unit B group has a bi-, tri-, tetra-, or octa-branched structure, it preferably has a diol group at each branched terminal. In the present specification, a so-called linear polymer is also included in the term “branched polymer” as a bi-branched polymer.

In addition, in the present specification, the terms “A group” and “B group” are used in the sense that they may each include a plurality of polymer units having different structures, and include not only the case of a combination of a plurality of polymer units but also the case of being composed of only one polymer unit.

In a preferred aspect, the polymer unit A group can include a combination of polymers having a total of four boronic acid-containing groups at a terminal and polymers having a total of eight boronic acid-containing groups at a terminal; and the polymer unit B group can include a combination of polymers having a total of four diol groups at a terminal and polymers having a total of eight diol groups at a terminal.

As the hydrophilic polymer, a polymer having affinity for water known in the art can be used, but is preferably a biocompatible polymer having a polyalkylene glycol skeleton or a polyvinyl skeleton.

Examples of the polymer having a polyalkylene glycol skeleton preferably include polymer species having a plurality of branches of a polyethylene glycol skeleton, and particularly, bi-, tri-, tetra-, or octa-branched polyethylene glycols are preferable. A polymer material composed of a tetra-branched polyethylene glycol skeleton is generally known as a Tetra-PEG polymer material, and is known to have a network structure network constructed by an AB-type cross-end coupling reaction between tetra-branched polymers each having two or more kinds of functional groups capable of reacting with each other at the terminal (Matsunaga et al., Macromolecules, Vol. 42, No. 4, pp. 1344-1351, 2009). In addition, the Tetra-PEG polymer material can be easily prepared in situ by simple two-liquid mixing of each polymer solution, and it is also possible to control the polymer materialization time by adjusting the pH and ionic strength during preparation of the polymer material. In addition, since the polymer material contains PEG as a main component, the polymer material is also excellent in biocompatibility.

Examples of the hydrophilic polymer having a polyvinyl skeleton include polyalkyl methacrylates such as polymethyl methacrylate, polyacrylates, polyvinyl alcohols, poly N-alkyl acrylamides, and polyacrylamides.

In a preferred aspect, the branched polymers constituting the polymer unit A group and B group are hydrophilic polymers. The branched polymer constituting the polymer unit A group and B group may have a polyethylene glycol skeleton or a polyvinyl skeleton. Alternatively, at least one of the branched polymers constituting the polymer unit A group and B group can be independently composed of only bi-, tri-, tetra-, or octa-branched polyethylene glycols. For example, it is also possible to use a combination in which the polymer unit A group is composed of tetra-branched polyethylene glycol and the polymer unit B group is polyvinyl alcohol.

The hydrophilic polymer has a weight average molecular weight (Mw) in the range of 5×10³ to 1×10⁵, preferably in the range of 1×10⁴ to 5×10⁴. Preferably, the branched polymers constituting the polymer unit A group and B group all have a molecular weight (Mw) of 5×10³ to 1×10⁵.

When the polymer unit A group and B group have such a boronic acid-containing group and a diol group, as exemplified in the following equilibrium reaction scheme, the boronic acid site and the OH group of the diol chemically react with each other to obtain the polymer material of the present invention having a structure in which polymer units are linked and associated with each other. The specific structures of the boronic acid-containing group and the diol group shown in the reaction scheme are merely examples and are not limited thereto, and other types of boronic acid-containing groups and diol groups may be used as described later.

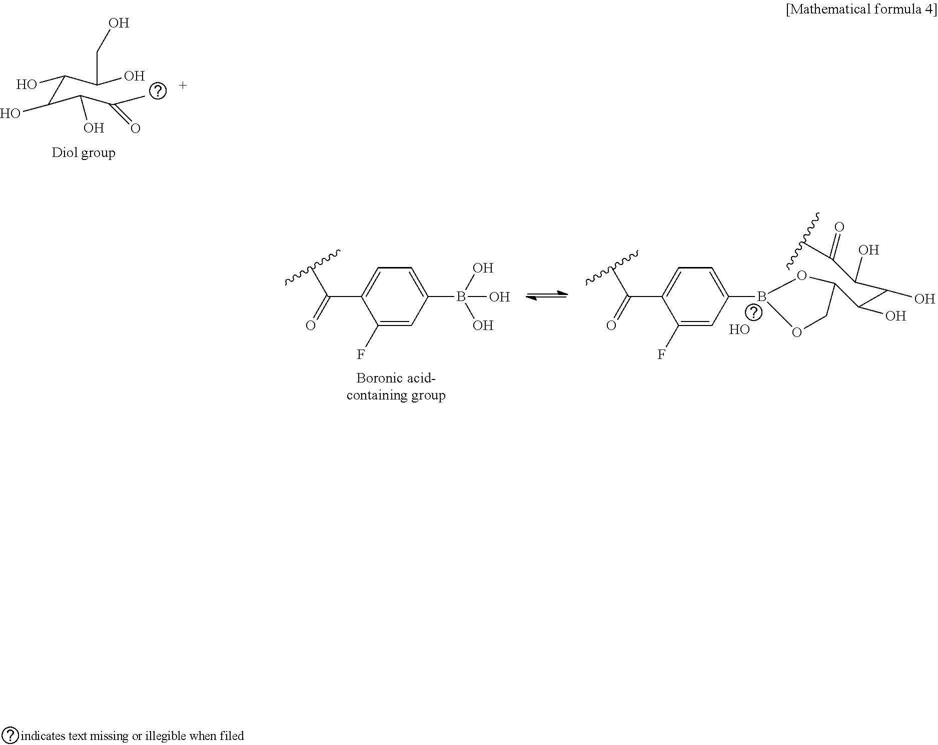

The boronic acid-containing group present in the polymer unit A group is not particularly limited as long as it has a structure having a boronic acid, and can be, for example, an arylboronic acid, preferably an arylboronic acid that may be substituted with a halogen atom. As the arylboronic acid, phenylboronic acid is preferable. The boronic acid-containing groups may be the same or different, but are preferably the same. When the functional groups are the same, reactivity with the diol group becomes uniform, and a polymer material having a uniform structure is easily obtained.

The diol group present in the polymer unit B group is not particularly limited as long as it is a functional group having two or more hydroxyl groups (OH groups) such as 1,2-diol and 1,3-diol, and can be a saccharide or a saccharide derivative. A sugar alcohol having a structure derived from a sugar, preferably a sugar alcohol having a ring-opened structure of a saccharide derivative can be used. Such a saccharide may be any of a monosaccharide, a disaccharide, and a polysaccharide, but can typically be a monosaccharide such as glucose or fructose. In addition, the diol group may be an aromatic diol group or an aliphatic diol group, and may be a diol group in which one or more carbons in the molecule are substituted with a hetero atom. The diol groups may be the same or different, but are preferably the same. When the functional groups are the same, reactivity with the boronic acid-containing group becomes uniform, and a polymer material having a uniform structure is easily obtained.

As described above, the number-average number of functional groups of the boronic acid-containing group per molecule in the polymer unit A group is in the range of 3 to 100, preferably in the range of 3 to 60. Further, the number-average number of functional groups of diol group per molecule in the polymer unit B group is in the range of 3 to 1500, preferably in the range of 3 to 100, and more preferably in the range of 3 to 60. By setting the number of such functional groups within a predetermined range and setting the polymer unit concentration so as to satisfy the formula of the average number of bonds N described later, a desired phase-separated structure is obtained. Here, the “number-average number of functional groups” is an average value of the number of boronic acid-containing groups or diol groups per molecule of the branched polymer included in the polymer unit A group or B group.

Preferable non-limiting specific examples of the branched polymer constituting the polymer unit A group include a compound represented by the following formula (I) having four branches of a polyethylene glycol skeleton and having a boronic acid-containing group at each terminal.

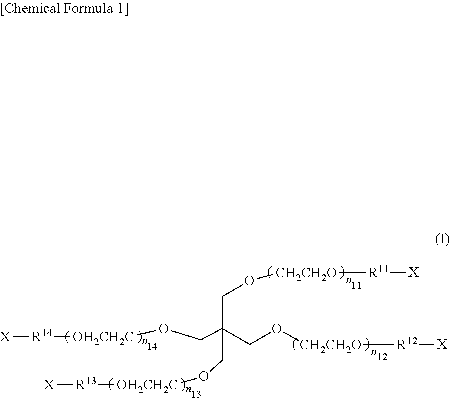

In the formula (I), X is a boronic acid-containing group, and in a preferred embodiment, X can be a phenylboronic acid-containing group or a fluorophenylboronic acid-containing group having the following structure (in the partial structure, the wavy line portion is a connection portion to R¹¹ to R¹⁴).

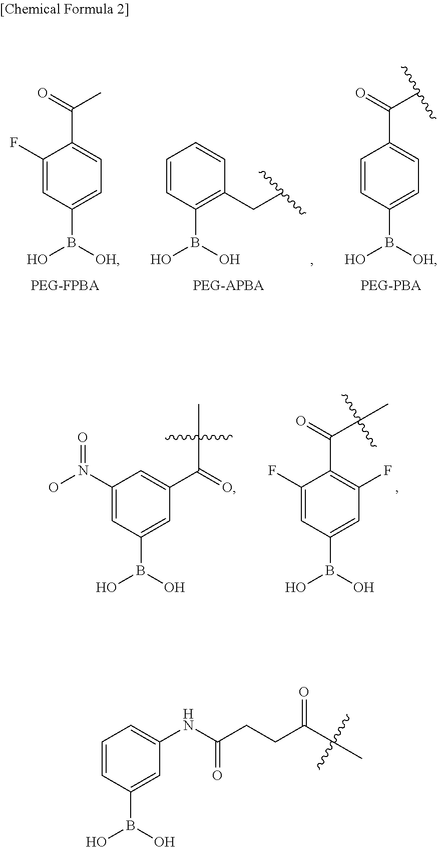

In the formula (I), n₁₁ to n₁₄ may be the same or different. As the values of n₁₁ to n₁₄ are closer, a uniform three-dimensional structure can be obtained, and the strength becomes higher. Therefore, in order to obtain a high-strength polymer material, n₁₁ to n₁₄ are preferably the same. When the values of n₁₁ to n₁₄ are too high, the strength of the polymer material becomes weak, and when the values of n₁₁ to n₁₄ are too low, the polymer material is hardly formed due to steric hindrance of the compound. Therefore, examples of n₁₁ to n₁₄ include an integer value of 25 to 250, preferably 35 to 180, more preferably 50 to 115, and particularly preferably 50 to 60.

In the formula (I), R¹¹ to R¹⁴ are the same or different, and each represent a linker moiety connecting a functional group and a core portion. R¹¹ to R¹⁴ may be the same or different, but are preferably the same in order to produce a high-strength polymer material having a uniform three-dimensional structure. R¹¹ to R¹⁴ each represent a direct bond, a C₁-C₇ alkylene group, a C₂-C₇ alkenylene group, —NH—R¹⁵—, —CO—R¹⁵—, —R¹⁶—O—R¹⁷—, —R¹⁶—NH—R¹⁷—, —R¹⁶—CO₂—R¹⁷—, —R¹⁶—CO₂—NH—R¹⁷—, —R¹⁶—CO—R¹⁷—, or —R¹⁶—CO—NH—R¹⁷—. Here, R¹⁵ represents a C₁-C₇ alkylene group. R¹⁶ represents a C₁-C₃ alkylene group. R¹⁷ represents a C₁-C₈ alkylene group.

Here, the “C₁-C₇ alkylene group” means an alkylene group having 1 or more and 7 or less carbon atoms which optionally have a branch, and means a linear C₁-C₇ alkylene group or a C₂-C₇ alkylene group having one or more branches (the number of carbon atoms including the branch is 2 or more and 7 or less). Examples of the C₁-C₇ alkylene group are a methylene group, an ethylene group, a propylene group, and a butylene group. Examples of C₁-C₇ alkylene groups include —CH₂—, —(CH₂)₂—, —(CH₂)₃—, —CH(CH₃)—, —(CH₂)₃—, —(CH(CH₃))₂—, —(CH₂)₂—CH(CH₃)—, —(CH₂)₃—CH(CH₃)—, —(CH₂)₂—CH(C₂H₅)—, —(CH₂)₆—, —(CH₂)₂—C(C₂H₅)₂—, and —(CH₂)₃C(CH₃)₂CH₂—.

The “C₂-C₇ alkenylene group” is a linear or branched alkenylene group having 2 to 7 carbon atoms and 1 or 2 or more double bonds in the chain, and examples thereof include a divalent group having a double bond formed by excluding 2 to 5 hydrogen atoms of adjacent carbon atoms from the alkylene group.

On the other hand, preferable non-limiting specific examples of the branched polymer constituting the polymer unit B group include a compound represented by the following formula (II) having four branches of a polyethylene glycol skeleton and having a diol group at each terminal.

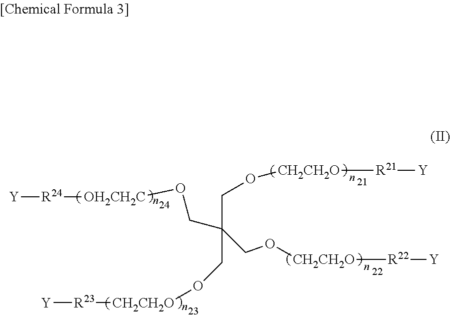

In the formula (I), Y is a diol group, and in a preferred embodiment, Y can be a group having the following structure (in the partial structure, the wavy line portion is a connection portion to R²¹ to R²⁴).

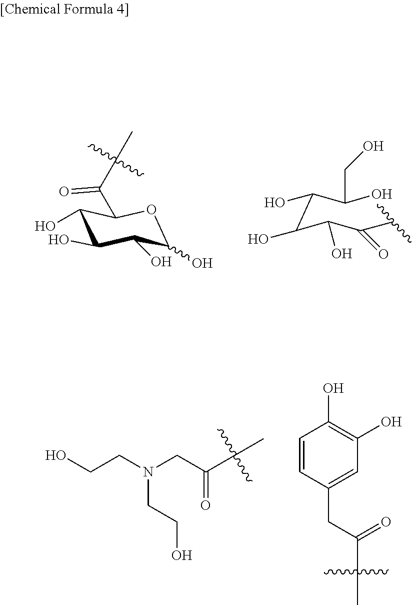

In the above formula (II), n₂₁ to n₂₄ may be the same or different. As the values of n₂₁ to n₂₄ are closer, the polymer material can have a uniform three-dimensional structure, resulting in high strength, and thus it is preferable, and it is preferable that the values are the same. When the values of n₂₁ to n₂₄ are too high, the strength of the polymer material becomes weak, and when the values of n₂₁ to n₂₄ are too low, the polymer material is hardly formed due to steric hindrance of the compound. Therefore, examples of n₂₁ to n₂₄ include an integer value of 5 to 300, preferably 20 to 250, more preferably 30 to 180, still more preferably 45 to 115, and still more preferably 45 to 55.

In the above formula (II), R²¹ to R²⁴ represent a linker moiety connecting a functional group and a core portion. R²¹ to R²⁴ may be the same or different, but are preferably the same in order to produce a high-strength polymer material having a uniform three-dimensional structure. In the formula (II), R²¹ to R²⁴ are the same or different and each represent a direct bond, a C₁-C₇ alkylene group, a C₂-C₇ alkenylene group, —NH—R²⁵—, —CO—R²⁵—, —R²⁶—O—R²⁷—, —R²⁶—NH—R²⁷—, —R²⁶—CO₂—R²⁷—, —R²⁶—CO₂—NH—R²⁷—, —R²⁶—CO—R²⁷—, or —R²⁶—CO—NH—R²⁷—. Here, R²⁵ represents a C₁-C₇ alkylene group. R²⁶ represents a C₁-C₃ alkylene group. R²⁷ represents a C₁-C₅ alkylene group.

In the present specification, the alkylene group and the alkenylene group optionally have one or more optional substituents. Examples of the substituent include, but are not limited to, an alkoxy group, a halogen atom (may be any of a fluorine atom, a chlorine atom, a bromine atom, and an iodine atom), an amino group, a mono- or disubstituted amino group, a substituted silyl group, an acyl group, or an aryl group. When the alkyl group has two or more substituents, they may be the same or different. The same applies to alkyl moieties of other substituents including alkyl moieties (for example, alkyloxy groups and aralkyl groups).

In addition, in the present specification, when a certain functional group is defined as “optionally having a substituent”, the type of the substituent, the substitution position, and the number of substituents are not particularly limited, and when having two or more substituents, they may be the same or different. Examples of the substituent include, but are not limited to, an alkyl group, an alkoxy group, a hydroxyl group, a carboxyl group, a halogen atom, a sulfo group, an amino group, an alkoxycarbonyl group, and an oxo group. Substituents may be further present in these substituents.

### (1-2) Polymer Unit Concentration and Connectivity

In the polymer material of the present invention, the total concentration (C₁) of the polymer unit A group and B group is 1 to 200 g/L, preferably 5 to 100 g/L. At the same time, the total concentration C₁ is in the range of 0.02 to 3 times the overlapping concentration (C₁+) of the polymer units, preferably in the range of 0.1 to 2.

Here, the “overlapping concentration” (also called “overlap concentration”) is a concentration at which polymers in a solvent start to spatially come into contact with each other, and in general, the overlap concentration c* is represented by the following expression.

$${c}^{*} = 3 {M}_{w} / ( 4 π \cdot α \cdot {N}_{A} \cdot {R}_{g}^{3} ) \qquad [ Mathematical formula 5 ]$$

(wherein M_{w} is the weight average molecular weight of the polymer; α is the relative density of the solvent; NA is the Avogadro constant; R_{g} is the radius of gyration of the polymer).

For a method of calculating the overlap concentration c*, for example, Polymer Physics (M. Rubinstein, R. Colby) can be referred to. Specifically, for example, the overlap concentration can be determined by measuring the viscosity of a dilute solution using the Flory-Fox Equation.

In addition, the polymer material of the present invention is characterized in that the connectivity between polymer units is within a predetermined range. As a result, a desired phase-separated structure is obtained. More specifically, when the average number of boronic acid-containing groups or diol groups bonded to another polymer unit per molecule of the polymer unit is N, N satisfies the following relational expression.

$$N > 0.02 + 4 {( c / {c}^{*} )}^{1.5} \qquad [ Mathematical formula 6 ]$$

Here, as described below, the bonding average number N can be calculated using an equilibrium constant in a reaction between polymer units.

Using the equilibrium constant K in the reaction between the polymer unit A group and B group, the network connectivity p, which is the ratio of the number of linked bonds and the total number of reactive functional groups (that is, boronic acid-containing groups and diol groups) in the equilibrium state, can be calculated. Here, the bond formation between the polymer units is a secondary reaction. Thus, the kinetics of bond formation can be expressed as follows.

$$\begin{matrix}[ Mathematical formula 7 ] & \\ \frac{{dn}_{bond}}{dt} = {k}_{a} ( {n}_{F , 0} - {n}_{bond} ) ( {n}_{G , 0} - {n}_{bond} ) - {k}_{d} {n}_{bond} & ( S 11 )\end{matrix}$$

Here, n_{bond} is the molar concentration of the bond, and n_{F,0} and n_{G,0} are the initial concentrations of the polymer unit A group and the polymer unit B group, respectively.

At equilibrium, association and dissociation are balanced (dn_{bond}/dt=0). Therefore, when equation (s11) is rewritten, n_{bond} is expressed as follows.

$$\begin{matrix}[ Mathematical formula 8 ] & \\ {n}_{b o n d} = \frac{1}{2} ( {n}_{F , 0} + {n}_{G , 0} + \frac{1}{K} ) - {\frac{1}{2} [ {( {n}_{F , 0} + {n}_{G , 0} + \frac{1}{K} )}^{2} - 4 {n}_{F , 0} {n}_{G , 0} ]}^{2} & ( S 12 )\end{matrix}$$

Here, the network connectivity p can be expressed as follows.

$$\begin{matrix}[ Mathematical formula 9 ] & \\ p = \frac{{n}_{bond}}{{n}_{F , 0} + {n}_{G , 0}} & ( S 13 )\end{matrix}$$

For example, when the boronic acid-containing group in the polymer unit A group and the diol group in the polymer unit B group are mixed so as to be in equal amount (n_{F,0}=n_{G,0}=½C_{end}), p is expressed as follows from the equation (S12) and the equation (S13).

$$\begin{matrix}[ Mathematical formula 10 ] & \\ p = ( 1 + \frac{1}{{C}_{end} K} ) - {[ {( 1 + \frac{1}{{C}_{end} K} )}^{2} - 1 ]}^{\frac{1}{2}} & ( S 14 )\end{matrix}$$

On the other hand, when the boronic acid-containing group and the diol group are mixed in non-equal amounts (n_{F,0}/(N_{F,0}+N_{G,0})=s, n_{F,0}+N_{G,0}=C_{end}), it can be expressed as follows.

$$\begin{matrix}[ Mathematical formula 11 ] & \\ p = ( 1 + \frac{1}{{C}_{e n d} K} ) - {[ {( 1 + \frac{1}{{C}_{e n d} K} )}^{2} - 4 s ( 1 - s ) ]}^{\frac{1}{2}} & ( S {14}^{′} )\end{matrix}$$

Using the above equation, the average number (N) of bonded reactive functional groups per molecule of a polymer unit having the number (f) of branches in an actual system can be calculated as follows.

$$\begin{matrix}[ Mathematical formula 12 ] & \\ N = pf = f ( 1 + \frac{1}{{C}_{e n d} K} ) - {[ {( 1 + \frac{1}{{C}_{e n d} K} )}^{2} - 4 s ( 1 - s ) ]}^{\frac{1}{2}} & ( S {14}^{′′} )\end{matrix}$$

### (1-3) Connectivity Adjusting Agent

In a preferred embodiment, a connectivity adjusting agent can be further included in order to set the above-described bonding average number N to an appropriate range. Such a connectivity adjusting agent roughly includes (1) a compound that can inhibit the bonding between polymer units to some extent, and (2) a compound that can adjust the surrounding environment that affects the bonding between polymer units.

Examples of the compound (1) capable of inhibiting the bonding between polymer units to some extent include saccharides such as glucose and saccharide derivatives such as sorbitol. Further, examples of the compound (2) capable of adjusting the surrounding environment include a pH adjusting agent. As such a pH adjusting agent, a pH buffering agent known in the art can be used.

The addition amount of the connectivity adjusting agent can be appropriately adjusted, and for example, when a saccharide derivative is used, it can be in the range of 0.1 to 50 in terms of molar ratio with respect to the monomer unit B group.

### (1-4) Physical Properties and the Like of Polymer Material

The polymer material of the present invention contains a solvent and has a polymer content of 200 g/L or less, preferably 150 g/L or less, more preferably 100 g/L or less. The lower limit value of the polymer content is not particularly limited, but the lower limit value is preferably 0.1 g/L or more from the viewpoint of obtaining desired physical properties such as viscosity.

The polymer material of the present invention has a porous structure in the order of μm and an aggregate structure due to a phase-separated structure.

Specifically, the mesh size constituted by the first regions can be 1 to 500 μm, and is preferably 10 to 100 μm. The mesh size means the length of the long side in the mesh unit (that is, the hole) in which the outer periphery is formed by the first region in a concentrated phase. Alternatively, in a case where the mesh unit is substantially circular, the mesh unit may have a length of a diameter thereof. The second region in a dilute phase, and/or the solvent are present inside the mesh unit. Alternatively, there is an aggregated concentrated phase with a pore size of 1 to 500 μm, preferably 10 to 100 μm, in the dilute phase.

Typically, the first region in a concentrated phase has a polymer concentration of 1 to 20 wt %, based on the entire gel containing the solvent, and the second region in a dilute phase has a polymer concentration of 0 to 3 wt %. Preferably, the first region has a polymer concentration of 1 to 10 wt % and the second region has a polymer concentration of 0.01 to 2 wt %.

As the solvent contained in the polymer material of the present invention, any solvent can be used as long as the associate formed by the polymer unit is dissolved, but typically, water or an organic solvent can be used. As the organic solvent, alcohols such as ethanol and polar solvents such as DMSO can be used. Preferably, the solvent is water.

The polymer material of the present invention can be typically produced by mixing a raw material containing a polymer unit A group and a raw material containing a polymer unit B group. When a solution containing a polymer unit is used as a raw material, the concentration, addition rate, mixing rate, and mixing ratio of each solution are not particularly limited, and can be appropriately adjusted by those skilled in the art. As described above, water, alcohols such as ethanol, DMSO, and the like can be used as the solvent of the solution. When the solution is an aqueous solution, an appropriate pH buffer such as a phosphate buffer can be used. Preferably, the polymer material of the present invention can be prepared by using a kit described below.

### (1-5) Kit and Production Method

In another aspect, the present invention relates to a kit for forming the polymer material and a method for producing the polymer material.

Such a kit includes a container separately storing a first solution containing a polymer unit A group composed of one or more branched polymers having a total of two or more boronic acid-containing groups in a side chain or a terminal; and a second solution containing a polymer unit B group composed of one or more polymers having a total of two or more diol groups in a side chain or a terminal, in which
the number-average number of functional groups per molecule in the polymer unit A group is in a range of 3 to 60, and the number-average number of functional groups per molecule in the polymer unit B group is in a range of 3 to 1500.

Here, the polymer units in the two solutions are set in the following concentration ranges. The total polymer concentration (c) when the first and second solutions are mixed is 0.1 to 100 g/L and ranges from 10⁻³ to 5 times the overlapping concentration (c*) of the polymer units.

Thereby, the above-described polymer material of the present invention can be obtained in-situ by mixing the first and second solutions. Details of the types and the like of the polymer unit A group and B group are as described above.

In a preferred aspect, at least one of the first and second solutions can further contain a connectivity adjusting agent. The details of the type and the like of the connectivity adjusting agent are as described above.

The solvent in the first and second solutions is water, but in some cases, can be a mixed solvent containing alcohols such as ethanol and other organic solvents. Preferably, these polymer solutions are aqueous solutions using water as a sole solvent. The volume of each polymer solution can be appropriately adjusted according to the area of the affected part or the like to which they are applied, the complexity of the structure, and the like, and is typically in the range of 0.1 to 20 ml, and preferably 1 to 10 ml.

The pH of each polymer solution typically ranges from 4 to 8, and preferably ranges from 5 to 7. For adjusting the pH of the polymer solution, a pH buffering agent known in the art can be used. For example, the pH can be adjusted to the above range by using a citric acid-phosphate buffer (CPB) and changing the mixing ratio of citric acid and disodium hydrogen phosphate.

As a means for mixing these polymer solutions, for example, a two-liquid mixing syringe as disclosed in the international publication WO2007/083522 can be used. The temperature of the two liquids at the time of mixing is not particularly limited as long as the polymer units are each dissolved and the respective liquids have fluidity. For example, the temperatures of the two liquids may be different, but it is preferable that the temperatures are the same because the two liquids are easily mixed.

In some cases, as the container in the kit of the present invention, an instrument such as a sprayer storing a polymer solution can be used. As the sprayer, a known sprayer in the art can be appropriately used, and a medical sprayer is preferable.

In another aspect, the present invention also relates to a method for producing the above-described polymer material. The production method includes a step of mixing a polymer unit A group including one or more branched polymers having a total of two or more boronic acid-containing groups in a side chain or a terminal, a polymer unit B group including one or more polymers having a total of two or more diol groups in a side chain or a terminal, and a solvent to prepare a polymer solution.

Here, the number-average number of functional groups per molecule in the polymer unit A group is in a range of 3 to 60, and the number-average number of functional groups per molecule in the polymer unit B group is in a range of 3 to 1500;
the total polymer concentration (c) in the polymer solution is 0.1 to 100 g/L and ranges from 10⁻³ to 5 times the overlapping concentration (c*) of the polymer units; and
when the average number of the boronic acid-containing group or the diol group bonded to another polymer unit per molecule of the polymer unit is N, N satisfies the following relational expression.

$$N > 0.02 + 4 {( c / {c}^{*} )}^{1.5} \qquad [ Mathematical formula 13 ]$$

In a preferred aspect, at least one of the first and second solutions can further contain a connectivity adjusting agent. Alternatively, the production method of the present invention may include a step of separately adding a third solution containing a connectivity adjusting agent.

Details of each polymer unit and the connectivity adjusting agent are as described above.

### EXAMPLES

Hereinafter, the present invention will be described in more detail with reference to Examples, but the present invention is not limited thereto.

### 1. Preparation of Polymer Material

### 1-1. Synthesis of Polymer Unit

Tetra-PEG-GDL and Octa-PEG-GDL having a diol group (ring-opened structure of gluconolactone) at the terminal of tetra-branched or octa-branched tetrapolyethylene glycol, and Tetra-PEG-FPBA and Octa-PEG-FPBA having a fluorophenylboronic acid group at the terminal were synthesized as polymer units constituting a polymer material.

The following raw materials were used.
Tetra-PEG-NH₂ (Molecular weights Mw of 5 k, 10 k, and 20 k were used; Yuka Sangyo Co., Ltd.);
Octa-PEG-NH₂ (Molecular weights Mw of 5 k, 10 k, and 20 k were used; Yuka Sangyo Co., Ltd.);
4-carboxy-3-fluorophenylboronic acid (FPBA) (FUJIFILM Wako Pure Chemical Corporation);
4-(4,6-dimethoxy-1,3,5-triazin-2-yl)-4-methylmorpholinium chloride (DMT-MM) (FUJIFILM Wako Pure Chemical Corporation); and
Glucono-δ-lactone (GDL) (Tokyo Chemical Industry Co., Ltd.).

### Synthesis of Tetra-PEG-GDL

Tetra-PEG-NH₂ having an amino group at the terminal was dissolved in methanol at a concentration of 50 mg/mL, 10 times of gluconolactone and 20 times of triethylamine were added in molar ratio to the terminal amino group of Tetra-PEG-NH₂, and the mixture was stirred at 35° C. for 3 days. The reaction solution was transferred to a dialysis membrane (MWCO for 20 k: 6-8,000, MWCO for 10 k, 5 k: 3,500), dialyzed with methanol for 2 days and water for 2 days, passed through a 0.45 μm syringe filter, then freeze-dried, and collected as a powder. The completion of the synthesis was confirmed by ¹H—NMR.

### Synthesis of Tetra-PEG-FPBA

Tetra-PEG-NH₂ was dissolved in methanol at a concentration of 50 mg/mL, 5 times FPBA and 10 times DMT-MM were added in molar ratio to the terminal amino group of Tetra-PEG-NH₂, and the mixture was stirred at room temperature overnight. The reaction solution was transferred to a dialysis membrane (MWCO for 20 k: 6-8,000, MWCO for 10 k, 5 k: 3,500), dialyzed for half a day with an aqueous hydrochloric acid solution (10 mM), half a day with an aqueous sodium hydroxide solution (10 mM), half a day with a phosphate buffer (pH 7.4, 10 mM), one day with saline (100 mM), and finally one day with pure water, and passed through a 0.45 μm syringe filter, then freeze-dried, and collected as a powder. The completion of the synthesis was confirmed by ¹H-NMR.

Using octa-branched PEG as a raw material, various polymer units having a GDL terminal and FPBA were prepared in the same manner.

Synthesis of multi-branched PEG-GDL and multi-branched PEG-FPBA

Active ester terminated Tetra-PEG-OSu (product name: SUNBRIGHT PTE-100HS; Yuka Sangyo Co., Ltd.) and amine-terminated Tetra-PEG-NH₂ (product name: SUNBRIGHT PTE-100PA; Yuka Sangyo Co., Ltd.) were dissolved in a phosphate buffer having a pH of 7.4 so as to be 60 g/L. Each solution was mixed at a volume ratio of 0.14:0.86 to prepare a solution immediately before gelation. This solution was dialyzed against water, and then freeze-dried to obtain a powder. The resulting powder PEG is a multi-branched (multi-branched PEG-NH₂) having an excess of amine terminals.

Multi-branched PEG-NH₂ was dissolved in methanol at a concentration of 50 mg/mL, and 10 equivalents of gluconolactone and 20 equivalents of triethylamine were added in terms of molar ratio with respect to the NH₂ terminal, followed by stirring at 35° C. for 3 days. The reaction solution was transferred to a dialysis membrane (MWCO for 20 k: 6-8,000, MWCO for 10 k, 5 k: 3,500), dialyzed against methanol and deionized water for 1 day each, and filtered through a 0.45 μm syringe filter. Thereafter, the reaction solution was freeze-dried, and the reaction product was recovered as a GDL terminal-modified product (multi-branched PEG-GDL). On the other hand, the multi-branched PEG-NH₂ was dissolved in methanol at a concentration of 50 mg/mL, 5 equivalents of FPBA, 10 equivalents of DMT-MM in molar ratio to the NH₂ terminal were added and stirred at room temperature overnight. The reaction solution was transferred to a dialysis membrane (MWCO for 20 k: 6-8,000, MWCO for 10 k, 5 k: 3,500), dialyzed for half a day with an aqueous hydrochloric acid solution (10 mM), half a day with an aqueous sodium hydroxide solution (10 mM), half a day with a phosphate buffer (pH 7.4, 10 mM), one day with saline (100 mM), and finally one day with pure water, and passed through a 0.45 μm syringe filter, and then freeze-dried to collect FPBA modified-product (multi-branched PEG-FPBA).

### 1-2. Synthesis of Polymer Material

A solution containing the obtained polymer unit and a solution optionally containing a saccharide derivative as a connectivity adjusting agent were prepared, and these polymer solutions were mixed to synthesize a polymer material having the composition shown in the following table.

TABLE 1

| | Diol | Boronic acid | | | | |
|---|---|---|---|---|---|---|
| | terminal | terminal | | | Saccharide | |
| | (weight | (weight | | | derivative | |
| | average | average | Polymer | Saccharide | content | |
| | molecular | molecular | content | derivative | (molar ratio | |
| | weight) | weight) | (g/L) | additive | to diol group) | pH |
| Example | 8-branched- | 8-branched- | 0.1-120 | Sorbitol | 0-32 | 7.4 |
| 1 | PEG (20k) | PEG (20k) | | | | |
| Example | 8-branched | 8-branched | 20-80 | None | None | 7.4 |
| 2 | PEG (20k) + | PEG (20k) + | | | | |
| | 4 branched | 4 branched | | | | |
| | PEG (10k) | Peg (10k) | | | | |
| | (terminal | (terminal | | | | |
| | molar ratio: | molar ratio: | | | | |
| | 0-1) | 0-1) | | | | |
| Example | multi- | multi- | 10-30 | None | None | 7.4 |
| 3 | branched | branched | | | | |
| | (58- | (58- | | | | |
| | branched) | branched) | | | | |
| | PEG | PEG | | | | |
| | (molecular | (molecular | | | | |
| | weight | weight | | | | |
| | 2800k) | 2800k) | | | | |

In Example 3, the obtained multi-branched PEG-FPBA and multi-branched PEG-GDL were dissolved at 10, 20, and 30 g/L in a phosphate buffer having a pH of 7.4, and mixed in equal amounts to obtain a polymer material. The number of branches and the molecular weight of the multi-branched PEG were estimated from the measurement of the intrinsic viscosity [η] using an Ubbelohde viscometer using the Mark-Houwink-Sakurada equation ([η]=KM^{α}). K and α refer to literature values of PEG-water system (Rauschkolb et al. Biointerface Research in Applied Chemistry 2021).

### 2. Evaluation of Phase-Separated Structure

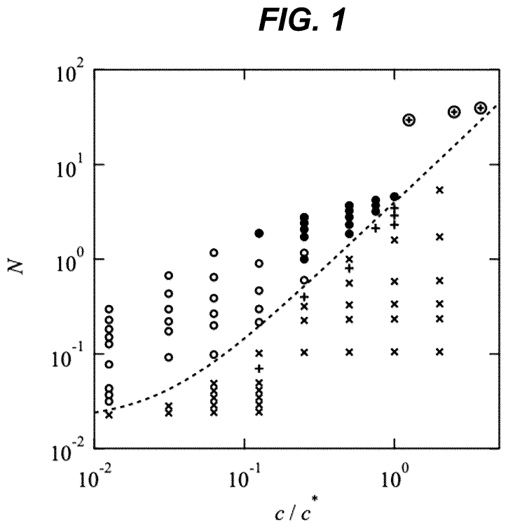

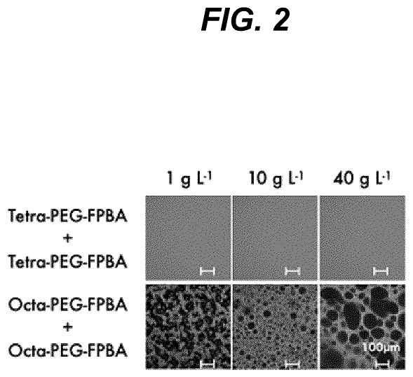

FIG. 1 shows a plot of results of checking the presence or absence of formation of a phase-separated structure for the various polymer materials synthesized in the above section 1. Here, for checking of formation of a phase-separated structure, a sample subjected to fluorescence modification such as fluoroscein was observed with a confocal laser microscope (LSM800, manufactured by Zeiss) at an excitation wavelength of 498 nm and an observation wavelength of 598 nm, and the sample in which a structure (that is, structures indicated by different colors on the acquired image) of 5 μm or more was confirmed as a phase-separated structure (FIG. 2).

### Synthesis of Fluorescence-Modified Sample

Tetra-PEG-NH₂ or Octa-PEG-NH₂ (molecular weights Mw of 5 k, 10 k, and 20 k were used; Yuka Sangyo Co., Ltd.) was dissolved in methanol at a concentration of 50 mg/ml, reacted with 0.001 times the amount of Fluorescein isothiocyanate (FITC) (manufactured by Sigma Aldrich) to the NH₂ terminal, and stirred at 25° C. for 1 day. Thereafter, 10 times the amount of gluconolactone and 20 equivalents of triethylamine were added to the NH₂ terminal, and stirred at 35° C. for 3 days. The reaction solution was transferred to a dialysis membrane (MWCO for 20 k: 6-8,000, MWCO for 10 k, 5 k: 3,500), dialyzed against methanol and deionized water for 1 day each, and filtered with a 0.45 μm syringe filter. Thereafter, the reaction solution was freeze-dried to recover the reaction product as a solid. The obtained fluorescence-modified Tetra-PEG-GDL and Octa-PEG-GDL were mixed with the Tetra-PEG-FPBA and Octa-PEG-FPBA synthesized in the above section 1 to obtain a fluorescence-modified sample. It has been confirmed that there is almost no change in physical properties due to the fluorescence modification.

In FIG. 1, the horizontal axis represents the total concentration (c) of polymer units/the overlapping concentration (c*) of polymer units; and the vertical axis represents the average number N of the boronic acid-containing group or the diol group bonded to another polymer unit per molecule of the polymer unit.

Example 1 shows the result of mixing 8-branched PEG-FPBA and 8-branched PEG-GDL and controlling the bonding property by the amount of sorbitol added. In FIG. 1, the symbol “◯” indicates that a phase-separated structure was confirmed to be formed, and the symbol “×” indicates that a single phase was formed without phase separation.

Example 2 shows the result of controlling the bonding property by mixing 8-branched PEG-FPBA, 8-branched PEG-GDL, 4-branched PEG-FPBA, and 4-branched PEG-GDL. In FIG. 1, the symbol “•” indicates that a phase-separated structure was confirmed to be formed, and the symbol “+” indicates that a single phase was formed without phase separation.

Example 3 shows the result of controlling the bonding properties by mixing the multi-branched PEG-FPBA and the multi-branched PEG-GDL. The symbol with + in ◯ in the upper right region in FIG. 1 indicates that a phase-separated structure is confirmed to be formed.

As a result of linear regression analysis on the plot of FIG. 1, it was found that a phase-separated structure is obtained when the following formula with c/c* as a variable is satisfied.

$$N > 0.02 + 4 {( c / {c}^{*} )}^{1.5} \qquad [ Mathematical formula 14 ]$$

1. A non-gelled polymer material containing a solvent,
the non-gelled polymer material having a three-dimensional structure in which a plurality of polymer units are linked such that a first region where the polymer units are densely present and a second region where the polymer units are sparsely present are present in a phase-separated state, wherein
the polymer unit includes a polymer unit A group including one or more branched polymers having a total of two or more boronic acid-containing groups in a side chain or a terminal, and a polymer unit B group including one or more branched polymers having a total of two or more diol groups in a side chain or a terminal,
the number-average number of functional groups of boronic acid-containing group per molecule in the polymer unit A group is in a range of 3 to 60, and the number-average number of functional groups of diol group per molecule in the polymer unit B group is in a range of 3 to 1500,
a total polymer concentration (c) in the polymer material is 0.1 to 100 g/L and ranges from 10⁻³ to 5 times an overlapping concentration (c*) of the polymer units, and
when the average number of the boronic acid-containing group or the diol group bonded to another polymer unit per molecule of the polymer unit is N, N satisfies the following relational expression.
$$N > 0.02 + 4 {( c / {c}^{*} )}^{1.5} \qquad [ Mathematical formula 1 ]$$

2. The polymer material according to claim 1, wherein the solvent is water, and the branched polymer constituting the polymer unit A group and B group is a hydrophilic polymer.

3. The polymer material according to claim 1, wherein the branched polymer constituting the polymer unit A group and B group has a polyethylene glycol skeleton or a polyvinyl skeleton.

4. The polymer material according to claim 1, wherein at least one of the polymer unit A group and B group is composed of only bi-, tri-, tetra-, or octa-branched polyethylene glycols.

5. The polymer material according to claim 1, wherein the branched polymers constituting the polymer unit A group and B group all have a molecular weight (Mw) of 5×10³ to 1×10⁵.

6. The polymer material according to claim 1, wherein the boronic acid-containing group is an arylboronic acid optionally substituted with a halogen atom.

7. The polymer material according to claim 1, wherein the diol group has a ring-opened structure of a saccharide derivative.

8. The polymer material according to claim 1, wherein
the polymer unit A group includes a combination of polymers having a total of four boronic acid-containing groups at a terminal and polymers having a total of eight boronic acid-containing groups at a terminal, and
the polymer unit B group includes a combination of polymers having a total of four diol groups at a terminal and polymers having a total of eight diol groups at a terminal.

9. The polymer material according to claim 1, further comprising a connectivity adjusting agent.

10. The polymer material according to claim 1, wherein a connectivity adjusting agent is selected from the group consisting of a saccharide, a saccharide derivative, and a pH adjusting agent.

11. A kit for forming the polymer material according to any one of claims 1 to 10, the kit comprising:
a container separately storing
a first solution containing a polymer unit A group including one or more branched polymers having a total of two or more boronic acid-containing groups in a side chain or a terminal, and
a second solution containing a polymer unit B group including one or more branched polymers having a total of two or more diol groups in a side chain or a terminal, wherein
the number-average number of functional groups of boronic acid-containing group per molecule in the polymer unit A group is in a range of 3 to 60, and the number-average number of functional groups of diol group per molecule in the polymer unit B group is in a range of 3 to 1500, and
the total polymer concentration (c) in the first and second solutions is 0.1 to 100 g/L and ranges from 10⁻³ to 5 times the overlapping concentration (c*) of the polymer units.

12. The kit according to claim 11, wherein at least one of the first and second solutions can further contain a connectivity adjusting agent.

13. The kit according to claim 11, wherein the connectivity adjusting agent is selected from the group consisting of a saccharide, a saccharide derivative, and a pH adjusting agent.

14. A method for producing the polymer material according to any one of claims 1 to 10, the method comprising:
a step of mixing a polymer unit A group including one or more branched polymers having a total of two or more boronic acid-containing groups in a side chain or a terminal, a polymer unit B group including one or more polymers having a total of two or more diol groups in a side chain or a terminal, and a solvent to prepare a polymer solution, wherein
the number-average number of functional groups per molecule in the polymer unit A group is in a range of 3 to 60, and the number-average number of functional groups per molecule in the polymer unit B group is in a range of 3 to 1500,
the polymer concentration (c) in the polymer solution is 0.1 to 100 g/L and ranges from 10⁻³ to 5 times the overlapping concentration (c*) of the polymer units, and
when the average number of the boronic acid-containing group or the diol group bonded to another polymer unit per molecule of the polymer unit is N, N satisfies the following relational expression.
$$N > 0.02 + 4 {( c / {c}^{*} )}^{1.5} \qquad [ Mathematical formula 2 ]$$
